(19) United States
(12) Patent Application Publication
(10) Pub. No.: US 2026/0113312 A1
(43) Pub. Date: Apr. 23, 2026

(54) ROBUST SERVER DISPATCH METHOD AND SYSTEM

(71) Applicant: Charles Lap San CHAN, Taipei (TW)

(72) Inventor: Charles Lap San CHAN, Taipei (TW)

(21) Appl. No.: 19/362,923

(22) Filed: Oct. 20, 2025

(30) Foreign Application Priority Data
Oct. 22, 2024 (TW) 113140206

(51) Int. Cl. H04L 9/40

(52) U.S. Cl. CPC H04L 63/083

(57) ABSTRACT

A robust server dispatch method and system operate in a network environment including an index server, a plurality of client devices, and a plurality of private servers. The index server stores private server data including company codes and IP addresses. A client device sends a connection request including a company code, a personal code, and a password to the index server. The index server retrieves the corresponding private server IP address and forwards the request to the appropriate private server, which verifies the request and, upon successful verification, allows the client device to connect. The method effectively distributes processing loads, enhancing system performance, stability, and data security.

### BACKGROUND OF THE INVENTION

This application claims priority for the TW patent application no. 113140206 filed on 22 Oct. 2024, the content of which is incorporated by reference in its entirely.

### FIELD OF THE INVENTION

The present invention relates to a server dispatch method and system, and more particularly, to a dispatch server method and system capable of distributing processing loads.

### DESCRIPTION OF THE RELATED ART

In modern corporate environments, index servers play a crucial role, providing essential information retrieval services for numerous employees across different companies. However, the traditional single index server architecture faces significant limitations and potential risks when confronted with large-scale, diverse usage demands.

Firstly, when a single index server simultaneously serves a large number of employees from multiple companies, its processing capacity faces severe challenges. As the number of users increases and query complexity rises, the server's computational resources and network bandwidth can easily become saturated. This not only leads to prolonged response times and reduced query efficiency but can also cause system instability, affecting the overall quality of service.

Secondly, a single-server architecture is susceptible to a single point of failure. If the index server goes down due to hardware failure, software errors, or network issues, all users relying on the service will lose connection simultaneously. In such a scenario, the business operations of multiple companies could be brought to a standstill, resulting in severe economic losses and reduced efficiency.

Furthermore, different companies and departments may have their own unique indexing needs and security requirements. A single server struggles to flexibly accommodate these diverse demands, facing challenges in resource allocation, permission management, and data isolation. This not only impacts the level of service customization but may also raise concerns regarding data security and privacy.

With the development of cloud computing and distributed system technologies, the industry has recognized the limitations of the traditional single index server model. However, how to effectively design and implement a distributed indexing system that can simultaneously meet the requirements of high availability, high performance, and high security remains a pressing technical problem to be solved.

Therefore, developing a solution that can overcome the aforementioned drawbacks and provide a more stable, efficient, and flexible indexing service is of great significance for enhancing corporate data retrieval capabilities, ensuring business continuity, and promoting collaborative work efficiency.

### SUMMARY OF THE INVENTION

The primary objective of the present invention is to provide a server dispatch method and system capable of distributing processing loads.

Another objective of the present invention is to provide a server dispatch method and system that can accommodate the unique configuration needs of different companies and departments.

To achieve the above objectives, the present invention provides a robust server dispatch method, operating in an environment of an index server, a plurality of client devices, and a plurality of private servers, wherein the index server, the plurality of client devices, and the plurality of private servers are interconnected via a network. The method comprises the following steps:
Step (A) storing a plurality of private server data corresponding to the plurality of private servers in the index server, wherein the private server data for each private server includes a company code and a private server IP address;
Step (B) one of the plurality of client devices sending a connection request to the index server, the connection request including the company code, a personal code, and a password;
Step (C) querying, by the index server, the plurality of private server data based on the company code to obtain the private server IP address;
Step (D) forwarding, by the index server, the connection request to the private server corresponding to the private server IP address;
Step (E) verifying, by the private server, whether the connection request is valid based on the personal code and the password; and
Step (F) if the verification is successful, allowing the client device to connect to the private server.

Below, the embodiments are described in detail in cooperation with the drawings to make easily understood the technical contents, characteristics and accomplishments of the present invention.

### BRIEF DESCRIPTION OF THE DRAWINGS

FIG. 1 is a schematic diagram of a system architecture of a robust server dispatch system according to a preferred embodiment of the present invention; and

FIG. 2 is a flowchart of a robust server dispatch method according to a preferred embodiment of the present invention.

### DETAILED DESCRIPTION OF THE INVENTION

The present invention provides a robust server dispatch method and system for operation in a network environment comprising an index server, multiple client devices, and multiple private servers. By distributing processing loads, the method and system of the present invention effectively overcome the limitations of a single-server architecture, enhance the overall performance and stability of the system, and better meet the individual configuration needs of different companies, while ensuring data security and privacy.

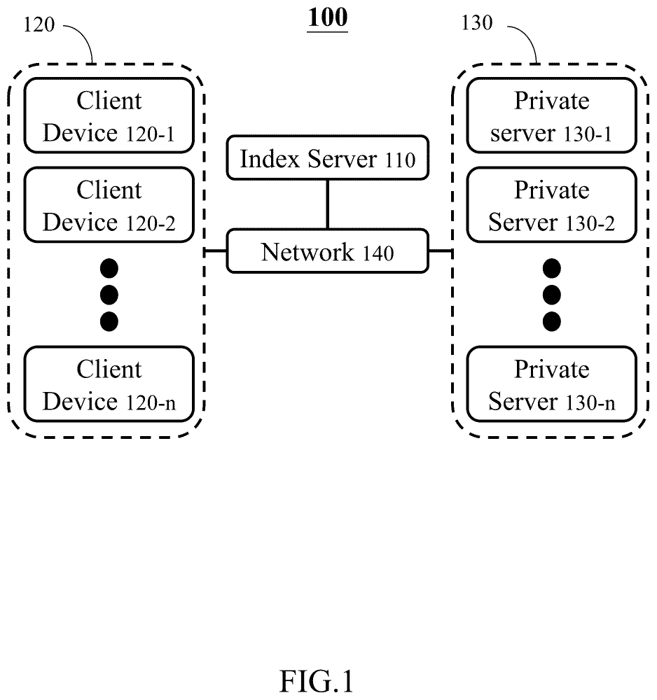

Referring to FIG. 1, a schematic diagram of a system architecture of a robust server dispatch system 100 according to a preferred embodiment of the present invention is shown. The system 100 comprises an index server 110, a plurality of client devices 120 (120-1, 120-2, . . . , 120-n), and a plurality of private servers 130 (130-1, 130-2, . . . , 130-n). The index server 110, client devices 120, and private servers 130 are interconnected via a network 140. The network 140 can be any suitable communication network, such as the Internet, a Local Area Network (LAN), a Wide Area Network (WAN), or a combination thereof.

The index server 110 is equipped with a processor, memory, and a network interface (not shown). The memory stores a plurality of private server data entries, each corresponding to one of the plurality of private servers 130. The client devices 120 can be various forms of computing devices, including but not limited to smartphones, tablets, laptops, desktop computers, or other smart devices capable of network connectivity.

The private server data corresponding to each private server 130 includes a company code and a private server IP address. For example, in the index server 110, the private server data corresponding to the private server 130-1 may include the company code “COMPANY_A” and the IP address “60.251.110.38”.

The index server 110 is configured to receive connection requests (not shown) from the client devices 120. Each connection request includes a company code, a personal code, and a password. For example, a connection request sent by a user via the client device 120-1 may contain the user's company code “COMPANY_A”, the user's personal code “USER_001”, and the user's password “PASSWORD123”.

Upon receiving a connection request, the index server 110 queries the stored private server data based on the company code in the request to obtain the corresponding private server IP address. For example, the index server 110 queries the private server data stored in its memory based on the company code “COMPANY_A” in the request and obtains the corresponding IP address “60.251.110.38”. Then, the index server 110 forwards the connection request to the private server 130-1 corresponding to that IP address “60.251.110.38”.

Each private server 130 in the present invention is also equipped with a processor, memory, and a network interface (not shown). The memory stores multiple personal codes and their corresponding passwords. For example, the private server 130-1 may store the personal code “USER_001”and its corresponding password “PASSWORD123”.

When a private server 130 receives a forwarded connection request from the index server 110, it performs verification based on the personal code and password in the request. If the verification is successful, the private server 130 allows the corresponding client device 120 to connect.

Furthermore, the private servers 130 in the present invention can be configured to store communication data of the client devices 120. This communication data may include text, voice, or image data generated during communication between a client device and other client devices. As different companies may have varying requirements for data security and privacy, the system provides flexible configuration options, allowing different companies to customize different levels of protection measures for their own private servers 130.

Ways to customize protection measures for the private server 130 may include: data encryption levels, access control, data retention policies, data backup and recovery, and secure data transmission, among others.

In the present invention, regarding data encryption levels, each private server 130 can implement different levels of encryption schemes according to the company's security needs. For example: (1) Basic Level, using standard AES-256 encryption algorithm to encrypt all stored data; (2) Advanced Level, using dual encryption, first with AES-256 and then a second encryption with RSA-4096; or (3) Top Level, implementing homomorphic encryption, which allows data processing in an encrypted state, further enhancing security.

In the present invention, regarding access control, system access control policies can be set, including: (1) Role-Based Access Control (RBAC), which assigns different data access permissions to different user roles; (2) Multi-Factor Authentication, requiring users to provide multiple forms of verification (such as a password and biometrics) to access sensitive data; (3) Access Logging, which records all data access operations in detail for auditing and anomaly detection.

In the present invention, data retention policies can be, for example: (1) Automatic Deletion, setting a lifecycle for data to be automatically deleted after a specific period; (2) Data Anonymization, automatically replacing personally identifiable information with anonymous identifiers after a certain point in time; (3) Tiered Storage, storing data in storage systems of different security levels based on its sensitivity and importance. In the present invention, methods for data backup and recovery can be, for example: (1) Real-time Backup, performing real-time synchronous backup of critical data; (2) Periodic Backup, performing incremental or full backups at preset time intervals; or (3) Geographically Dispersed Backup, storing backup data in different geographical locations to prevent regional disasters.

In the present invention, regarding secure data transmission, different levels of security measures are implemented during data transmission, for example: (1) TLS Encryption, using the latest TLS protocol to encrypt all network communications; (2) VPN Tunnel, establishing a dedicated VPN tunnel for particularly sensitive data transmissions; (3) End-to-End Encryption, performing encryption on the client device to ensure data remains encrypted throughout the entire transmission and storage process. Through these customization options, each company using the system can configure the most suitable data protection plan for its private server 130 according to its own needs and the specific requirements of its industry. This not only ensures data security and privacy but also meets the requirements of various regulations and industry standards.

To maintain system stability and reliability, another embodiment of the present invention provides a data update procedure. When a private server 130 detects a change in its own IP address, it executes a data update procedure. This procedure mainly includes the following steps: the private server 130 generates an update request containing the new private server IP address, a timestamp, and a digital signature; the private server 130 sends this update request to the index server 110; the index server 110 verifies the received update request; and if the verification is successful, the index server 110 updates its stored data corresponding to that private server. It should be understood that the data update procedure is not limited to only updating the new private server IP address.

Furthermore, in yet another embodiment of the present invention, a client device 120 can also trigger this update process. When a user determines that the data of a certain private server needs to be updated, the user can send a trigger request via the client device 120 to that private server 130, prompting the private server 130 to execute the aforementioned data update procedure. A user may determine the need to update a private server's data for reasons such as: (1) Response Timeout: If the client device 120 successfully connects to the private server 130, but the server's response time is abnormally long or frequently times out, it may indicate that the current connection path is not optimal and the private server's data may need updating. (2) Error Report Analysis: If the client device 120 collects an unusually high number of error reports or crash logs that may be related to the connection with a specific private server, it can trigger an update request for that server's data. (3) Load Balancing Hint: If the private server 130 sends a load balancing hint to the client device 120 (indicating that the current server load is too high), the client device 120 can trigger an update request based on this to potentially bring a backup server online.

Through this mechanism, the system 100 can timely update the IP address data of the private servers, ensuring that the client devices 120 can always accurately connect to the required private server. Moreover, when there are other considerations or a need to update other private server data, the client device 120 can also trigger this update process.

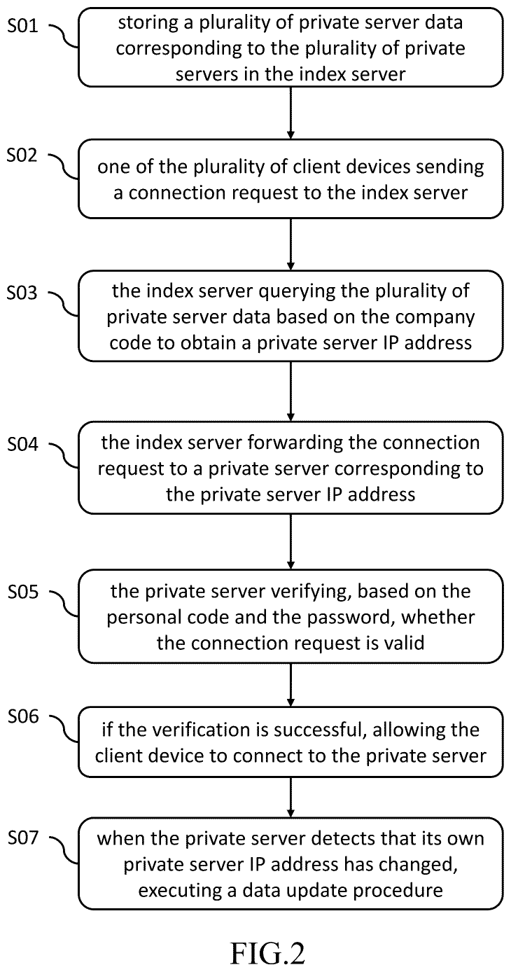

Referring to FIG. 2, a flowchart of a robust server dispatch method according to a preferred embodiment of the present invention is shown. First, in step S01, the system 100 stores the private server data corresponding to multiple private servers 130 into the index server 110. Specifically, the index server 110 saves a unique company code and the corresponding private server IP address for each private server 130. To enhance security, this data can optionally be stored in an encrypted format. This step lays the foundation for the entire system's operation, ensuring that the index server 110 can correctly direct client devices 120 to the appropriate private servers 130.

When a user needs to connect to a specific private server 130, step S02 is executed. In step S02, the client device 120 sends a connection request to the index server 110. This request contains three pieces of information: a company code, a personal code, and a password. The company code is used to identify the target private server, while the personal code and password are used for subsequent user identity verification. To protect the security of data transmission, the entire communication process can optionally use a secure protocol, such as TLS (Transport Layer Security). Additionally, the password can optionally be preliminarily encrypted on the client side before transmission to add an extra layer of security.

Next is step S03, where the index server 110, upon receiving the connection request, queries its stored private server data based on the company code in the request to obtain the corresponding private server IP address. To further improve efficiency, the system can optionally implement a query caching mechanism, allowing for faster retrieval of results for frequently accessed company codes.

In step S04, the index server 110 forwards the original connection request to the private server 120 at the corresponding IP address. This forwarding process also uses a secure communication channel to ensure that data is not stolen or tampered with during transmission.

Step S05 is the verification stage. The private server 130, upon receiving the forwarded request, uses the personal code and password in the request to perform identity verification. This verification process can use a secure password verification mechanism, for example, in one embodiment, encrypting the password with the bcrypt algorithm to prevent it from being cracked, though the invention is not limited to this.

In step S06, if the verification is successful, the private server 130 allows the client device 120 to connect to the private server 130. In the present invention, this connection process can further establish a secure communication channel, such as a VPN or another form of encrypted tunnel.

In the present invention, each private server independently stores multiple personal codes and their corresponding passwords. This design increases the system's security because even if the data of a private server managed by one company or organization is compromised, it will not affect the private servers of other companies or organizations. Furthermore, this authentication data can optionally be stored in an encrypted database, with periodic password updates and strong password policies implemented.

The present invention also considers the dynamic nature of the network environment, particularly the possibility of private server IP addresses changing, for which another embodiment of the invention may include step S07. In step S07, when a private server detects a change in its own private server IP address, it can execute a data update procedure, which is used to update the private server data corresponding to said private server in the index server. This procedure includes the private server generating an update request that contains the new private server IP address, a timestamp, and a digital signature.

The private server 130 sends this update request to the index server 110. Upon receiving the request, the index server 110 verifies its authenticity and timeliness. If the verification is successful, the index server 110 updates the corresponding private server data in its database. To handle potential network instability, the system can also optionally implement a retry mechanism to ensure the update request is eventually successful.

In addition to the above, in yet another embodiment of the present invention, the system also allows a client device 120 to trigger the update process of the private server data. In other words, in this further embodiment, step S07 involves the client device 120, upon determining a need to update the private server data, sending a trigger request to the private server 130 to execute a data update procedure, causing the index server 110 to update the corresponding private server data in its database. This mechanism enables the system to respond more quickly to changes in the network environment, improving overall reliability.

In sum, the robust server dispatch method provided by the present invention, through the meticulous design of steps S01 through S07, achieves a high degree of security, flexibility, and scalability. It is suitable for various scenarios requiring secure and dynamic server connection management, such as enterprise internal communication systems, multi-tenant cloud service platforms, and the like. Through the coordination of the index server 110, client devices can securely and efficiently connect to the correct private server 130, while the system can flexibly respond to changes in the network environment. This method not only improves the security and reliability of communication but also greatly simplifies the management and maintenance of the system.

While various examples of the disclosed technology have been described above, it should be understood that these examples have been presented by way of example only, and not limitation. Likewise, the various diagrams may depict example architectures or other configurations for the disclosed technology, which are provided to aid in understanding the features and functionality that can be included in the disclosed technology. The disclosed technology is not limited to the illustrated example architectures or configurations, but the desired features can be implemented using a variety of alternative architectures and configurations. Indeed, it will be apparent to one of skill in the art how alternative functional, logical, or physical partitioning and configurations can be implemented to implement the desired features of the technology disclosed herein. Additionally, with regard to flowcharts, operational descriptions, and method claims, the order in which the steps are presented herein should not require that the disclosed technology be implemented to perform the recited functionality in the same order, unless the context dictates otherwise.

The foregoing description is merely of the preferred embodiments of the present invention and is not intended to limit the scope of implementation of the present invention. Accordingly, all equivalent changes and modifications made in accordance with the shape, structure, features, and spirit described in the claims of the present invention should be included within the scope of the claims of the present invention.

What is claimed is:

1. A robust server dispatch method, operating in an environment of an index server, a plurality of client devices, and a plurality of private servers, wherein the index server, the plurality of client devices, and the plurality of private servers are interconnected via a network, the method comprising the following steps:
Step (A) storing a plurality of private server data corresponding to the plurality of private servers in the index server, wherein the private server data for each private server comprises a company code and a private server IP address;
Step (B) one of the plurality of client devices sending a connection request to the index server, the connection request comprising the company code, a personal code, and a password;
Step (C) querying, by the index server, the plurality of private server data based on the company code to obtain the private server IP address;
Step (D) forwarding, by the index server, the connection request to the private server corresponding to the private server IP address;
Step (E) verifying, by the private server and based on the personal code and the password, whether the connection request is valid; and
Step (F) if the verification is successful, allowing the client device to connect to the private server.

2. The robust server dispatch method as claimed in claim 1, wherein each of the plurality of private servers respectively stores a plurality of personal codes and a corresponding plurality of passwords.

3. The robust server dispatch method as claimed in claim 1, wherein communication data of the client device is stored only by the private server, the communication data comprising text, voice, or image data generated during communication between the client device and other client devices.

4. The robust server dispatch method as claimed in claim 1, further comprising the step of: Step (G) when the private server detects that its own private server IP address has changed, executing a data update procedure to update the private server data corresponding to the private server in the index server.

5. The robust server dispatch method as claimed in claim 4, wherein the data update procedure comprises: generating, by the private server, an update request comprising a new private server IP address, a timestamp, and a digital signature; sending, by the private server, the update request to the index server; verifying, by the index server, the update request; and if the verification is successful, updating, by the index server, the private server data corresponding to the private server.

6. The robust server dispatch method as claimed in claim 1, further comprising the step of: Step (G) when the client device determines that the private server data of the private server is to be updated, sending a trigger request to the private server to execute a data update procedure to update the private server data corresponding to the private server in the index server.

7. The robust server dispatch method as claimed in claim 6, wherein the data update procedure comprises: generating, by the private server, an update request comprising a new private server IP address, a timestamp, and a digital signature; sending, by the private server, the update request to the index server; verifying, by the index server, the update request; and if the verification is successful, updating, the index server, the private server data corresponding to the private server.

8. A robust server dispatch system, comprising:
an index server;
a plurality of client devices; and
a plurality of private servers;
wherein the index server, the plurality of client devices, and the plurality of private servers are interconnected via a network;
the index server stores a plurality of private server data corresponding to the plurality of private servers, wherein the private server data for each private server comprises a company code and a private server IP address, the index server receives a connection request from one of the plurality of client devices, the connection request comprising the company code, a personal code, and a password, the index server queries the plurality of private server data based on the company code to obtain the private server IP address, and then forwards the connection request to the private server corresponding to the private server IP address; and
the private server verifies, based on the personal code and the password, whether the connection request is valid, and upon successful verification, allows the client device to connect to the private server.

9. The robust server dispatch system as claimed in claim 8, wherein the private server is configured to: execute a data update procedure to update the private server data corresponding to the private server in the index server when the private server detects that its own private server IP address has changed.

10. The robust server dispatch system as claimed in claim 9, wherein the data update procedure comprises:
the private server generating an update request comprising a new private server IP address, a timestamp, and a digital signature;
the private server sending the update request to the index server;
the index server verifying the update request; and
if the verification is successful, the index server updating the private server data corresponding to the private server.

11. The robust server dispatch system as claimed in claim 8, wherein the client device is configured to: send a trigger request to the private server to execute a data update procedure to update the private server data corresponding to the private server in the index server, when the client device determines that the private server data of the private server is to be updated.

12. The robust server dispatch system as claimed in claim 11, wherein the data update procedure comprises:
the private server generating an update request comprising a new private server IP address, a timestamp, and a digital signature; and
the private server sending the update request to the index server;
the index server verifying the update request; and
if the verification is successful, the index server updating the private server data corresponding to the private server.
